(19) United States
(12) Patent Application Publication
(10) Pub. No.: US 2009/0141877 A1
(43) Pub. Date: Jun. 4, 2009

(54) SYSTEM AND APPARATUS FOR PREDICTIVE VOICE OVER INTERNET PROTOCOL (VoIP) INFRASTRUCTURE MONITORING UTILIZING ENHANCED CUSTOMER END-POINT VoIP PHONES

(76) Inventor: Luke Rowan McKenna, Western (AU)

Correspondence Address: IBM CORP (YA);C/O YEE & ASSOCIATES PC, P.O. BOX 802333, DALLAS, TX, 75380, US

(21) Appl. No.: 11/947,945

(22) Filed: Nov. 30, 2007

(51) Int. Cl. H04M 15/00

(52) U.S. Cl. 379/133; 455/405

(57) ABSTRACT

A method for the active and passive monitoring of a voice over internet protocol (VoIP) network infrastructure is provided. Monitoring software on a VoIP phone of the VoIP network infrastructure is configured to collect statistics associated with phone calls made or received by the VoIP phone. A silent phone call is made from the VoIP phone to another VoIP phone in the VoIP network infrastructure. Statistics associated with the silent phone call are collected. Additionally, normal phone calls made and received on the VoIP phone are also monitored. Statistics are collected for these monitored phone calls as well. The collected statistics are stored. The collected statistics are sent to a central monitor. The collected statistics are displayed to a user.

### BACKGROUND OF THE INVENTION

1. Field of the Invention

The present invention relates generally to data processing systems. More specifically, the present invention relates to a method, system and computer program product for the active monitoring of a VoIP network infrastructure, using enhanced VoIP phones.

2. Description of the Related Art

Voice over Internet Protocol (VoIP) service providers rely heavily on high performance networks, hardware and software. The service being provided is voice transfer. The quality of this service being provided is highly susceptible to decreases in the performance or availability of the underlying infrastructure. The monitoring of this underlying infrastructure is therefore not only important, but also necessary for the service providers to continue providing high quality service for their customers.

Currently available methods for monitoring the underlying VoIP infrastructure involve actively and passively monitoring the infrastructure and reacting to problems that are occurring or are about to occur. Currently, the amount of data obtainable through active monitoring of the infrastructure is limited. Current active monitoring solutions are centered around the idea of deploying stand-alone active testing agents that are installed at various points on a VoIP network. These stand-alone active testing agents are independently managed and configured. Among the drawbacks of this method are: (1) the distribution of these agents adds overhead to a VoIP network deployment; (2) the additional cost of hardware/software for these stand-alone active testing agents; and (3) the stand-alone active testing agents are often, due to the previous two drawbacks, not deployed at every end-point of a VoIP network. Thus, not all end-points of a VoIP network are independently actively monitored.

Thus, while great strides have been made in some areas of actively monitoring VoIP infrastructures, a need for improvement still exists.

### SUMMARY OF THE INVENTION

The exemplary embodiments provide a computer implemented method, apparatus, and computer usable program code for active monitoring of a voice over internet protocol (VoIP) network infrastructure. Monitoring software on a VoIP phone of the VoIP network infrastructure is configured to collect statistics associated with phone calls made or received by the VoIP phone. A silent phone call is made from the VoIP phone to another VoIP phone in the VoIP network infrastructure. Statistics associated with the silent phone call are collected, forming collected statistics. The collected statistics are stored. The collected statistics are sent to a central monitor. The collected statistics are displayed to a user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system is shown in which illustrative embodiments may be implemented;

FIG. 3 depicts a system for implementing the active and passive monitoring of a VoIP network infrastructure, using enhanced VoIP phones, in accordance with an exemplary embodiment;

FIG. 4 is a flowchart illustrating the operation of configuring a VoIP phone and active monitoring of a VoIP network infrastructure according to an exemplary embodiment; and

FIG. 5 is a flowchart illustrating the operation of actively monitoring of a VoIP network infrastructure, using enhanced VoIP phones according to an exemplary embodiment.

### DETAILED DESCRIPTION OF THE PREFERRED EMBODIMENT

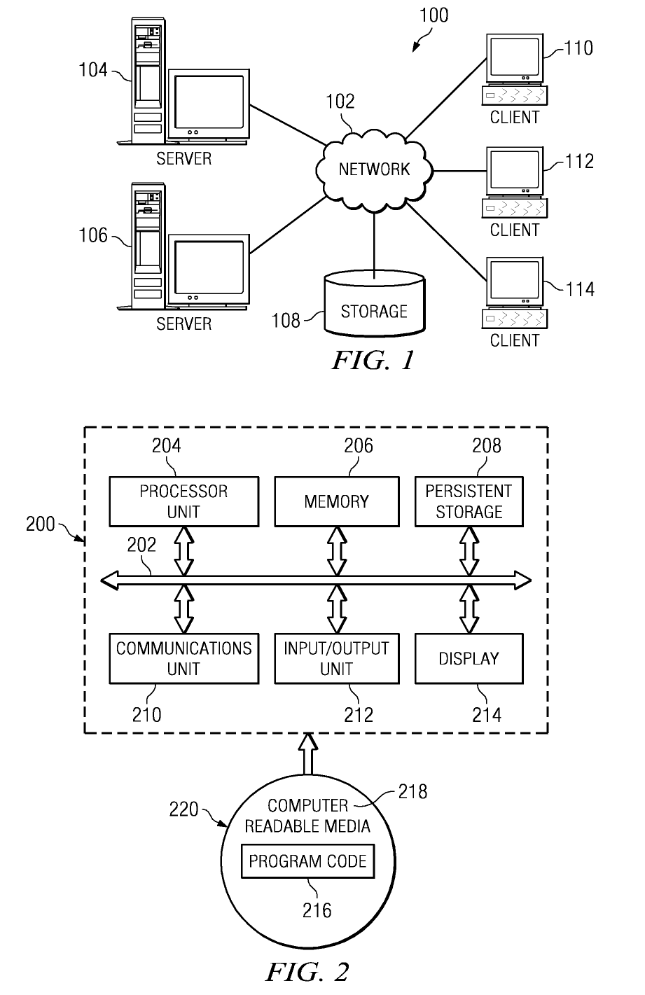

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Exemplary embodiments increase the coverage and input data for the monitoring of a VoIP infrastructure. Increasing either the amount of data or the accuracy of the data available on the current state of a provider's VoIP infrastructure, allows for increasing service levels past their current point. Exemplary embodiments increase the capabilities of the end customers VoIP hardware or software phones to include silent, periodic, active testing functionality. Additionally, exemplary embodiments combine these increased capabilities with a central monitoring server to improve the quality of service offered for a VoIP network and infrastructure.

Currently, the hardware or software VoIP phones at a customer's site are used to only make and receive live VoIP calls. A VoIP phone typically takes one of two forms, a hardware based VoIP phone or a software based VoIP phone. A hardware VoIP phone is an object that usually implements the basic functions and appearance of a traditional telephone. The difference between a hardware VoIP phone and traditional VoIP phone is that a hardware VoIP phone uses a computer network to transmit or receive the audio-based conversation that occurs between two or more parties. For a VoIP phone, the computer network is an internet protocol based network. The computer network can be either the internet, a LAN, or some other similar network implementations. A traditional phone uses an analog signal to send audio-based conversations; a hardware based VoIP phone system uses a digital signal to send the audio. A software based VoIP phone performs the same functions as a hardware based VoIP phone, except that a software VoIP phone is embodied in a computer program that can be installed on an existing data processing system.

Exemplary embodiments allow or enforce each phone on a VoIP network to silently and periodically make and receive calls between itself and other phones on the network. Enforcing means that the monitoring server controlling the monitoring behavior of the VoIP phones may optionally, not allow a user to disable the silent calling that is occurring on their VoIP phone. Further, exemplary embodiments allow, or force, each phone on a VoIP network to collect performance and availability information for all calls made or received by the phone and transmit this information to a monitoring center. The phones are not only collecting statistics on the real live customer calls, but the phones are silently making calls to the other phones in the network, whose performance and statistics are also monitored and reported.

Exemplary embodiments provide several advantages, such as integrating the stand-alone testing hardware and software into VoIP phones would reduce the need for independent active testing agents. Additionally, integrating the stand-alone testing hardware and software into VoIP phones would increase the breadth of coverage of the monitored VoIP network, as all end-points of the network will be able to produce monitoring data. Further, the VoIP phones would be able to contribute to predicting when the customer may experience performance or availability degradation by silently testing the VoIP infrastructure before the customer uses the phone, and reporting any problems encountered.

Exemplary embodiments provide for upgrading a VoIP phone's software to include active testing capabilities. Basically, the VoIP phone is able to silently make a call to another phone on the VoIP network and then record performance and availability statistics from these calls. A silent phone call is a VoIP call that is initiated by one VoIP phone and received by another VoIP phone without any user interaction with the VoIP phones or the users of the VoIP phones being aware of this call taking place. Software on the VoIP phone, whether the phone is a hardware or software based VoIP phone, performs these automated actions in combination with the controlling VoIP monitoring central server. During a silent phone call, a known audio recording is replayed during the call in order to simulate a voice being carried over a phone call. The silent phone call is monitored for performance and quality. The statistics available would be similar to those provided by an active testing VoIP agent that is currently available, such as response time, call quality, latency, connection status, and so forth. A central monitoring station is provided to manage the new capabilities of the VoIP phones. In an exemplary embodiment, the central monitoring station is part of the same infrastructure as the central VoIP server or server group.

The central monitoring station is able to configure the time interval between silent calls on all VoIP phones. Further, the central monitoring station is able to setup the silent call end-points and to randomly have all phones silently testing each other throughout the entire VoIP network. Introducing an element of randomness into the silent call scheduling and end-point setup allows the monitoring system to have an easy setup. For example, a user may be able to configure the phones by just clicking “randomize call length, period between calls, and end-points,” and the collected statistics would then be added to the already available real-call statistics and used to predict if the customer may experience problems when making a real call.

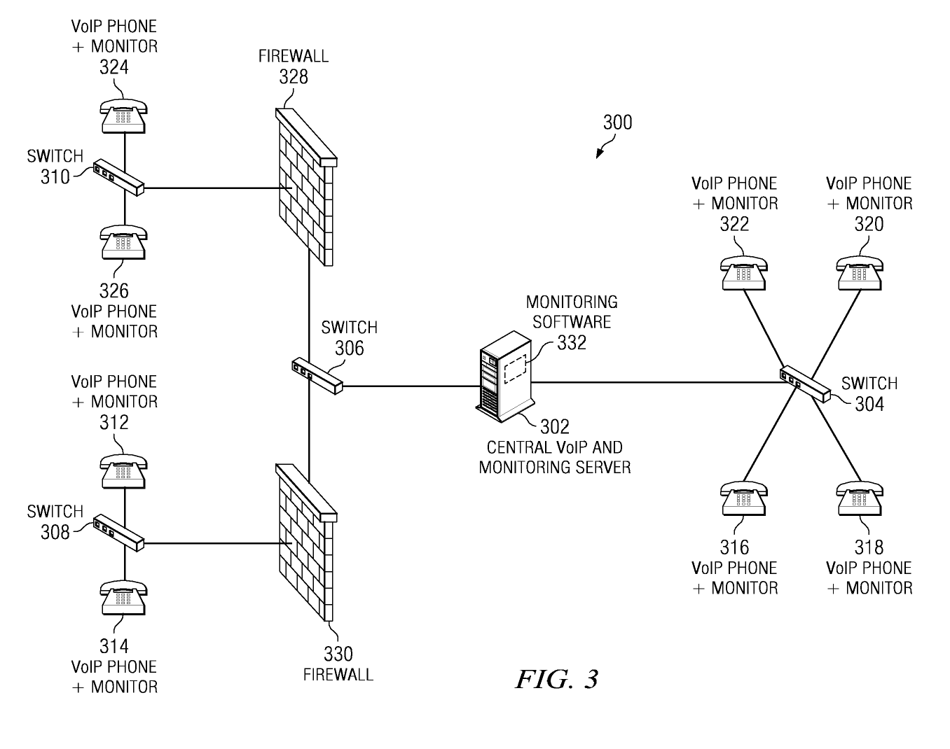

Turning back to the figures, FIG. 3 depicts a system for implementing the active and passive monitoring of a VoIP network infrastructure, using enhanced VoIP phones, in accordance with an exemplary embodiment. System 300 comprises central VoIP and monitoring server 302, switches 304, 306, 308, and 310, VoIP phones and monitors 312, 314, 316, 318, 320, 322, 324, and 326, firewalls 328 and 330, and monitoring software 332.

System 300 may be implemented as a network such as network data processing system 100 in FIG. 1. Central VoIP and monitoring server 302 may be implemented as a data processing system, such as data processing system 200 in FIG. 2. The architecture of FIG. 3 has been presented for purposes of illustration and description, and is not intended to be exhaustive or to limit exemplary embodiments to the architecture depicted. Many modifications and variations will be apparent to those of ordinary skill in the art. For example, system 300 may contain more or less VoIP phones than depicted. The exemplary embodiment was chosen and described in order to best explain the principles of the embodiments, the practical application, and to enable others of ordinary skill in the art to understand the various embodiments with various modifications as are suited to the particular use contemplated. Furthermore, either exemplary embodiments may be implemented in a VoIP hardware phone or a software based VoIP phone, known as a soft phone.

System 300 is an exemplary embodiment of an improved infrastructure where no additional hardware is required. Monitoring software 332 resides on central VoIP and monitoring server 302. Monitoring software 332 receives the statistics generated by the individual silent active monitors on each VoIP phone and monitor 312, 314, 316, 318, 320, 322, 324, and 326. Each VoIP phone and monitor 312, 314, 316, 318, 320, 322, 324, and 326 in system 300 can test any other VoIP phone and monitor on system 300. Each VoIP phone and monitor 312, 314, 316, 318, 320, 322, 324, and 326 is a VoIP phone with monitoring capabilities.

Each VoIP phone and monitor 312, 314, 316, 318, 320, 322, 324, and 326 collects and stores statistics regarding phone calls made or received by the VoIP phone. The statistics are stored in memory, such as memory 206 in FIG. 2. Some examples of the type of statistics collected and stored by the VoIP phones and monitors include, but are not limited to, response time, call quality, latency, connection status, and so forth. Each VoIP phone and monitor 312, 314, 316, 318, 320, 322, 324, and 326 is also configured to make silent calls to other VoIP phones in system 300 and collect and store the same set of statistics. The collected statistics are then sent to monitoring software 332 on central VoIP and monitoring server 302. The VoIP phones may be configured to send the collected statistics after each silent phone call is completed. Alternatively, the VoIP phones may be configured to send the collected statistics after all completed phone calls. As VoIP phones may only have limited memory space, the stored collected statistics are deleted once they are sent to monitoring software 332. Also, if a VoIP phone runs out of memory to store the collected statistics, the VoIP phone will write over the oldest data, storing and preserving the most recently collected information.

If periodic polling were set up for each silent monitor on every phone, then it is possible that connection problems or performance reductions could be detected before a real call is made. An engineer could then take corrective actions on the infrastructure to remedy the degradation in performance before a customer is even aware there was a problem. The advantage of having the real customer's phone doing silent active polling is that it accurately represents a customer's usage without having to wait for a real call to be made where any performance or availability problems could cause call quality to degrade.

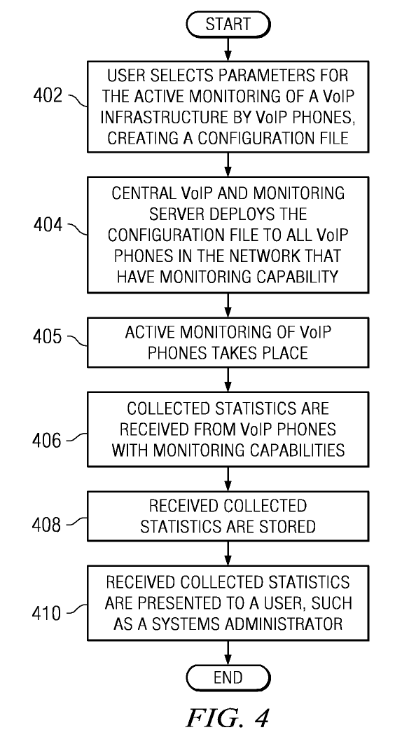

FIG. 4 is a flowchart illustrating the operation of configuring a VoIP phone and active monitoring of a VoIP network infrastructure according to an exemplary embodiment. The operation of FIG. 4 may be performed by monitoring software, such as monitoring software 332 of FIG. 3, implemented on a central VoIP and monitoring server, such as central VoIP and monitoring server 302 in FIG. 3.

The operation begins when a user selects parameters for the active monitoring of a VoIP infrastructure by VoIP phones, creating a configuration file (step 402). An example of parameters that a user may set includes, but is not limited to, call start time, call length, call initiator and receiver, audio file to play through call connection, and so forth. The central VoIP and monitoring server deploys, or pushes, the configuration file containing the selected settings to all VoIP phones in the network that have monitoring capability (step 404). Active monitoring of VoIP phones takes place (step 405). Collected statistics are received from VoIP phones with monitoring capabilities (step 406). The received collected statistics are stored (step 408) and presented to a user, such as a systems administrator, (step 410) and the operation ends.

The received collected statistics can be presented in a variety of ways, including, a printed written report, displayed on a terminal, separately for each VoIP phone, collectively, e-mailed to the user, and so forth. Furthermore, in an alternate exemplary embodiment, central VoIP and monitoring server 302 in FIG. 3 or monitoring software 332 in FIG. 3 analyzes the received collected statistics and alerts a user if any errors or potential problems are detected. The user can then instigate actions to correct the problem or prevent the problem from occurring.

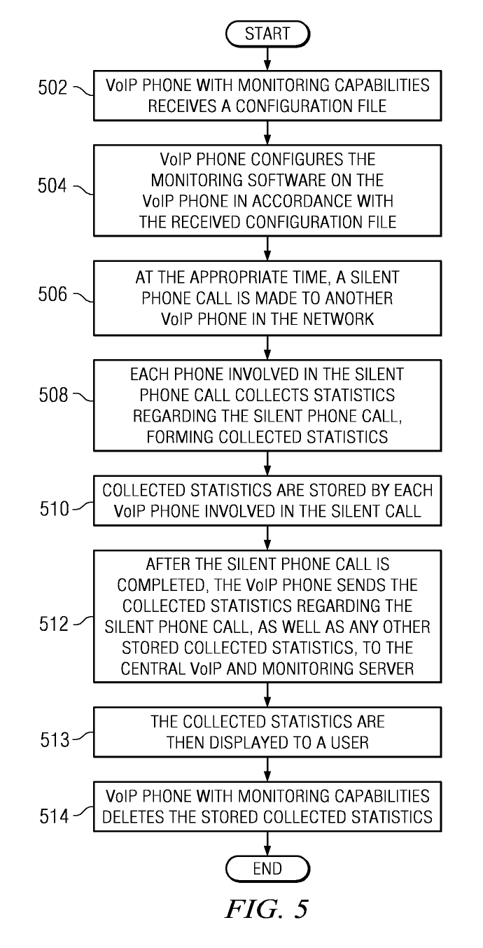

FIG. 5 is a flowchart illustrating the operation of actively monitoring of a VoIP network infrastructure, using enhanced VoIP phones according to an exemplary embodiment. The operation of FIG. 5 may be performed by a VoIP phone enhanced with monitoring capabilities, such as VoIP phone and monitor 312 in FIG. 3.

The operation begins when a VoIP phone with monitoring capabilities receives a configuration file (step 502). The VoIP phone configures the monitoring software on the VoIP phone in accordance with the received configuration file (step 504). At the appropriate time, a silent phone call is made to another VoIP phone in the network (step 506). The timing of the silent phone call is based on settings in the configuration file. For example, the VoIP phone may be configured to make a silent phone call at specific times of the day, such as 2 p.m., or at specific intervals, such as every 2 hours or 15 minutes after last made or received phone call, or the time could be a random interval. Further, the VoIP phone may be configured to call the same, specific phone each time a silent call is made, or the VoIP phone may be set to alternate calling between a group of phones or the VoIP phone may be set to randomly select another VoIP phone and call that phone for each silent phone call.

Each phone involved in the silent phone call collects statistics regarding the silent phone call, forming collected statistics (step 508). The collected statistics are stored by each VoIP phone involved in the silent call (step 510). The VoIP phones store the collected statistics in memory, such as memory 206 in FIG. 2. After the silent phone call is completed, the VoIP phone sends the collected statistics regarding the silent phone call, as well as any other stored collected statistics, to the central VoIP and monitoring server (step 512). The collected statistics are then displayed to a user (step 513). The VoIP phone with monitoring capabilities deletes the stored collected statistics (step 514) and the operation ends.

Thus, exemplary embodiments solve the problems in current active monitoring of VoIP network infrastructure. Exemplary embodiments increase the coverage and input data for the monitoring of a VoIP infrastructure. Increasing either the amount of data or the accuracy of the data available on the current state of a provider's VoIP infrastructure, allows for increasing service levels past their current point. Exemplary embodiments increase the capabilities of the end customers VoIP hardware or software phones to include silent, periodic, active testing functionality. Additionally, exemplary embodiments combine these increased capabilities with a central monitoring server to improve the quality of service offered for a VoIP network and infrastructure.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a storage media, a recordable media, semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and digital versatile disc (DVD).

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters are also coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for active monitoring of a voice over internet protocol (VoIP) network infrastructure, the computer implemented method comprising:
configuring monitoring software on a VoIP phone of the VoIP network infrastructure to collect statistics associated with phone calls made or received by the VoIP phone;
making a silent phone call from the VoIP phone to another VoIP phone in the VoIP network infrastructure;
collecting statistics associated with the silent phone call, forming collected statistics;
storing the collected statistics;
sending the collected statistics to a central monitor; and
displaying the collected statistics to a user.

2. The computer implemented method of claim 1, further comprising:
monitoring phone calls made and received on the VoIP phone, forming monitored phone calls;
collecting statistics associated with the monitored phone calls, forming monitored statistics;
storing the monitored statistics; and
sending the monitored statistics to the central monitor.

3. The computer implemented method of claim 1, further comprising:
deleting the stored monitored statistics.

4. The computer implemented method of claim 1, wherein the VoIP phone is a hardware VoIP phone.

5. The computer implemented method of claim 1, wherein the VoIP phone is a software VoIP phone.

6. The computer implemented method of claim 1, further comprising:
selecting a set of parameters for monitoring the VoIP network infrastructure to form selected parameters;
creating a configuration file based on the selected parameters; and
distributing the configuration file to VoIP phones of the VoIP network infrastructure; and
wherein the monitoring software on a VoIP phone of the VoIP network infrastructure is configured based on the configuration file.

7. The computer implemented method of claim 6, wherein the set of parameters comprises at least one of a call start time, a call length, a call initiator and a receiver, and an audio file to play through a call connection.

8. A computer program product comprising:
a computer recordable medium having computer usable program code for active monitoring of a voice over internet protocol (VoIP) network infrastructure, the computer program product comprising:
computer usable program code for configuring monitoring software on a VoIP phone of the VoIP network infrastructure to collect statistics associated with phone calls made or received by the VoIP phone;
computer usable program code for making a silent phone call from the VoIP phone to another VoIP phone in the VoIP network infrastructure;
computer usable program code for collecting statistics associated with the silent phone call, forming collected statistics;
computer usable program code for storing the collected statistics;
computer usable program code for sending the collected statistics to a central monitor; and
computer usable program code for displaying the collected statistics to a user.

9. The computer program product of claim 8, further comprising:
computer usable program code for monitoring phone calls made and received on the VoIP phone, forming monitored phone calls;
computer usable program code for collecting statistics associated with the monitored phone calls, forming monitored statistics;
computer usable program code for storing the monitored statistics; and
computer usable program code for sending the monitored statistics to the central monitor.

10. The computer program product of claim 8, further comprising:
computer usable program code for deleting the stored monitored statistics.

11. The computer program product of claim 8, wherein the VoIP phone is a hardware VoIP phone.

12. The computer program product of claim 8, wherein the VoIP phone is a software VoIP phone.

13. The computer program product of claim 8, further comprising:
computer usable program code for selecting a set of parameters for monitoring the VoIP network infrastructure to form selected parameters;
computer usable program code for creating a configuration file based on the selected parameters; and
computer usable program code for distributing the configuration file to VoIP phones of the VoIP network infrastructure; and
wherein the monitoring software on a VoIP phone of the VoIP network infrastructure is configured based on the configuration file.

14. The computer program product of claim 13, wherein the set of parameters comprises at least one of a call start time, a call length, a call initiator and a receiver, and an audio file to play through a call connection.

15. A data processing system for active monitoring of a voice over internet protocol (VoIP) network infrastructure, the data processing system comprising:
a bus;
a communications unit connected to the bus;
a storage device connected to the bus, wherein the storage device includes computer usable program code; and
a processor unit connected to the bus, wherein the processor unit executes the computer usable program code to configure monitoring software on a VoIP phone of the VoIP network infrastructure to collect statistics associated with phone calls made or received by the VoIP phone; make a silent phone call from the VoIP phone to another VoIP phone in the VoIP network infrastructure; collect statistics associated with the silent phone call, forming collected statistics; store the collected statistics; send the collected statistics to a central monitor; and display the collected statistics to a user.

16. The data processing system of claim 15, wherein the processor further executes the computer useable program code to monitor phone calls made and received on the VoIP phone, forming monitored phone calls; collect statistics associated with the monitored phone calls, forming monitored statistics; store the monitored statistics; and send the monitored statistics to the central monitor.

17. The data processing system of claim 15, wherein the processor further executes the computer useable program code to delete the monitored stored statistics.

18. The data processing system of claim 15, wherein the VoIP phone is a hardware VoIP phone.

19. The data processing system of claim 15, wherein the VoIP phone is a software VoIP phone.

20. The data processing system of claim 15, wherein the processor further executes the computer useable program code to selecting a set of parameters for monitoring the VoIP network infrastructure to form selected parameters; create a configuration file based on the selected parameters; and distribute the configuration file to VoIP phones of the VoIP network infrastructure; and wherein the monitoring software on a VoIP phone of the VoIP network infrastructure is configured based on the configuration file.
